(19) United States
(12) Patent Application Publication
(10) Pub. No.: US 2004/0096693 A1
(43) Pub. Date: May 20, 2004

(54) Compound of ruthenium complex and electroluminescence device using the same

(75) Inventors: Chun-Chi Lai, Taipei (TW); Shu-Mei Chang, Taipei (TW); Yu-Chou Chao, Taipei (TW); Sung-Cheng HU, Taoyuan (TW); Chan-Yuan Ho, Taoyuan (TW)

Correspondence Address: BACON & THOMAS, PLLC, 625 SLATERS LANE, FOURTH FLOOR, ALEXANDRIA, VA, 22314

(73) Assignee: CHUNG SHAN INSTITUTE OF SCIENCE & TECHNOLOGY, Taoyuan (TW)

(21) Appl. No.: 10/295,883

(22) Filed: Nov. 18, 2002

(51) Int. Cl. H05B 33/14; C09K 11/06

(52) U.S. Cl. 428/690; 428/917; 313/504; 252/301.16; 252/301.35; 546/2; 257/102

(57) ABSTRACT

A compound and a composition used for light-emitting medium of an electro-luminescence device are disclosed, which has the structure as formula (I):

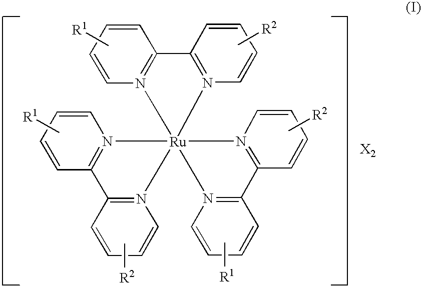

wherein each R¹ and R² independently is C₁₋₃ alkyl, C₆₋₁₀ aryl, or R¹ and R² are together to be —(CH═CH)—; X is Cl or Br.

The present invention also relates to an electro-luminescence device.

### BACKGROUND OF THE INVENTION

1. Field of the Invention

The present invention relates to a compound or a red fluorescent material that can be used as a dopant in organic light-emitting devices capable of light-emitting through conversion of electric energy into light, and a light emitting device using such a material. In particular, the invention is concerned with a light-emitting device suitably used in various areas of displays, indicators, illumination sources, sight boards etc.

2. Background of the Invention

Recently many researches and developments on flat panel displays have been made. Among these flat panel displays, the organic electroluminescence (OEL) devices attract considerable attention since they emit light of high intensity under low voltage. Generally speaking, organic electroluminescent displays (OLEDs) contain organic layers sandwiched between an anode and a cathode on a substrate, which emit electromagnetic radiation (typically light) in response to the application of an electric potential difference across the electrodes.

For achieving full-color display for an EL display panel, it is necessary to have efficient red, green and blue (RGB) EL materials with proper chromaticity and sufficient luminance efficiency. Fortunately, after intensive research worldwide, organic materials for green and blue OLEDs with high luminescence, high efficiency, saturated emissions, and practical lifetimes have been demonstrated. However, the corresponding development of organic materials for red electroluminescence significantly lags behind that of the other two primary colors. So far, most high-performance red OLEDs are made by doping a red dyes into a suitable host. For example, Tang et al. [U.S. Pat No. 4,769,292] disclosed a doped-based EL system on the principle of guest-host energy transfer to affect the spectral shift from the host tris-(8-hydroxyquinolinato) aluminum (Alq₃) to the dopant molecules. In this system, Alq₃ acts as a typical host for red EL emitters since its emission at 530 nm is adequate to sensitize guest EL emission in the red spectral region. On the other hand, the pyran-containing compounds, such as DCM, DCM2, DCJT, and DCJTB, have been widely applied as important red dopants for OLED application. These molecules generally have a high photoluminescence (PI.) quantum yield (>70% in dilute solution). However, their performance for functioning as red emitters is still significantly inferior to that of the typical green and blue emitters. In particular, their color saturation is far from ideal redness. Basically, this problem of color purity is partly due to the fact that the PL peaks of these compounds are in the range of 590˜615 nm. A large portion of their emission spectra is in fact below 600 nm, and thus the emission color appears orange. Since the pyran-containing compounds cannot emit a saturated red color, their applicability for the production of full-color EL display panel is limited. The emission peaks of the proper dopants have to be shifted further to the long wavelength region, so that the emission below 600 nm can be substantially reduced. Furthermore, other drawbacks, such as complicated synthetic procedures for these compounds, would significantly increase the production cost for red OLEDs. As a means of improving characteristics of red light emitting devices, the development of red light-emitting device materials capable of emitting longer-wavelength radiation and thus deliver a better red chromaticity (compared to DCM and DCJTB) becomes required. Other considerations in the fields of fluorescence and electroluminescence applications are the purity of fluorescent materials and the degree of synthetic complexities including consideration of yield loss due to post-process purification procedures. Accordingly, it is desirable to provide a fluorescent compound useful in EL applications which has a relatively high EL efficiency, a desired emission in the red region of the spectrum (640 nm) and is easy to synthesize and to purify.

In addition to the small molecule-based material system mentioned above, molecularly doped polymers (MDPs) with highly efficient fluorescent dye is also being considered as a useful material system for obtaining highly luminescent device efficiency. The utilization of polymers ( e.g. using poly (N-vinylcarbazole) (PVK) as a host) could prevent the recrystallization of small dopant molecules (dyes) when LEDs work and produce joule heat. The advantages illustrated above are believed from the good processibility and appreciable thermal stability of MDPs. In most cases, the devices are fabricated by spin-coating method. This method of making EL device has advantages over that of vacuum evaporation method from the viewpoints of simplicity of the manufacturing process, workability and ease in achievement of large-area luminescence.

Thus, the development of suitable red light-emitting material as a dopant in molecularly doped polymers (MDPs) with a better red light-emitting chromaticity and luminous efficiency has been awaited.

### SUMMARY OF THE INVENTION

The main object of the present invention is to provide a compound and an electroluminescence composition having better red chromaticity which can be used as a light-emitting material for an electroluminescence device.

Another object of the present invention is to provide a light emitting device or an electroluminescence device having excellent red chromaticity.

To obtain the purpose described above, the present invention provides a compound of formula (I):

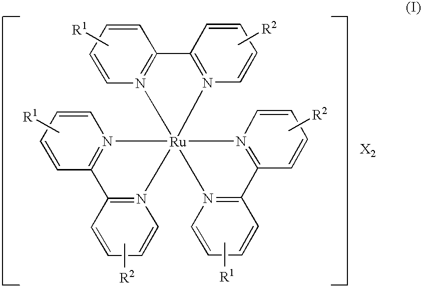

wherein each R¹ and R² independently is C₁₋₃ alkyl, C₆₋₁₀ aryl, or R¹ and R² are together to be —(CH═CH)—; X is Cl or Br.

The present invention also provides a composition for light-emitting medium of an electro-luminescence device, comprising a ruthenium complex as formula (I): a polymer matrix; and

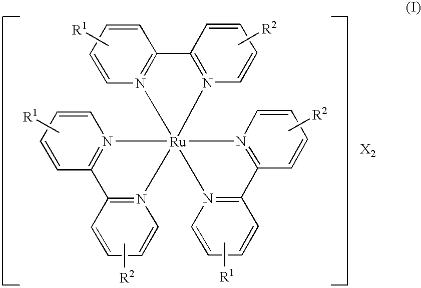

wherein each R¹ and R² independently is C₁₋₃ alkyl, C₆₋₁₀ aryl, or R¹ and R² are together to be —(CH═CH)—; X is Cl or Br.

The present invention further provides a red light-emitting device or an electroluminescence device, comprising at least one cathode, at least one anode, and a functional medium polymer doped with at least one compound as formula (I):

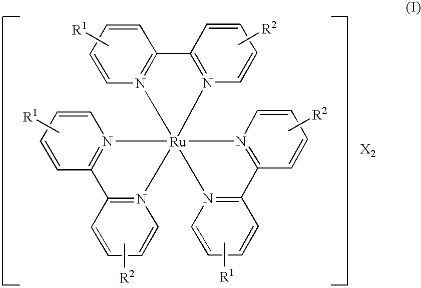

wherein each R¹ and R² independently is C₁₋₃ alkyl, C₆₋₁₀ aryl, or R¹ and R² are together to be —(CH═CH)—; X is Cl or Br; and said functional medium is sandwiched between said cathode and said anode.

### BRIEF DESCRIPTION OF THE DRAWINGS

FIG. 1 is a perspective view of the electroluminescence device of the present invention.

### DETAILED DESCRIPTION OF THE PREFERRED EMBODIMENT

The present invention relates to a composition used as red light devices material, which comprises a ruthenium complex, wherein each R¹ and R² independently is C₁₋₃ alkyl, C₆₋₁₀ aryl, or R¹ and R² are together to be —(CH═CH)—; X is Cl or Br. Preferably, each said R¹ and R² independently is methyl, phenyl. Or Preferably, R¹ and R² are together to be cis-(CH═CH)—. The preferred embodiments of the ruthenium complex are as following formula (II), (III) and (IV):

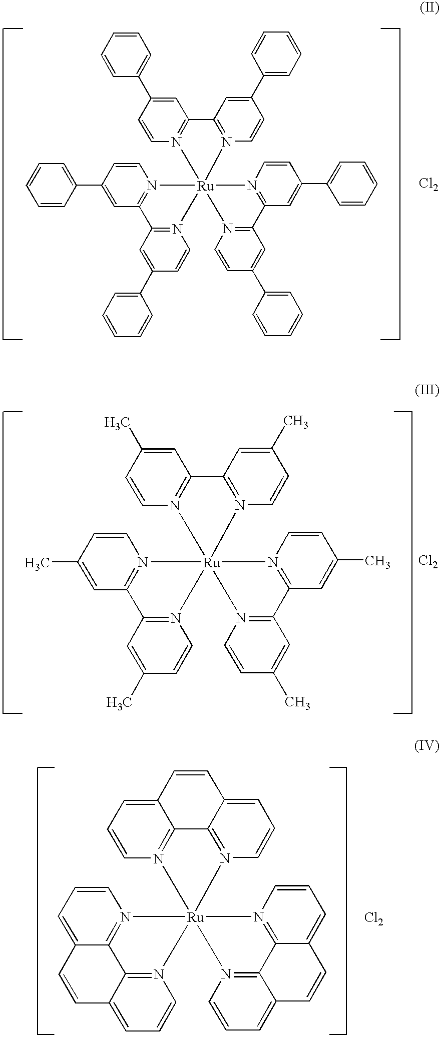

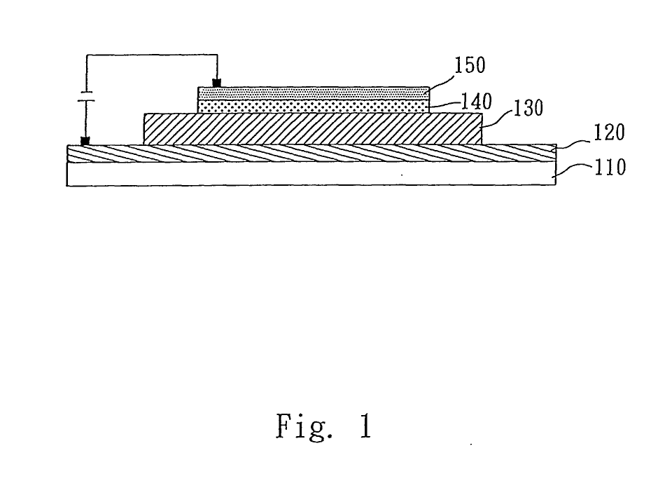

The present invention also relates to a red light-emitting device or an electroluminescence device containing the materials described above. The anode supplies a positive hole and the cathode supplies electron to the light-emitting layer (or the electroluminescence layer). Using the light-emitting material doped into the polymer according to the present invention, a light-emitting diode with a metal-semiconductor-metal structure shown in FIG. 1 is prepared. With reference with FIG. 1, the electroluminescence device of the present invention comprises a substrate 110, an ITO anode, a functional medium layer 130, a magnesium cathode 140, and a silver conductive layer 150. The light-emitting device or electroluminescence device of the invention comprises a functional medium layer 130 of molecularly doped polymer sandwiched between an anode 120 and a cathode 150. Here, at least one electrode should be transparent for the transmission of the emitted light. Preferably, the transparent electrode is anode.

The anode of the light-emitting device or the electroluminescence device is made of a material having a high work function. Preferably, the anode is made of indium tin oxide, gold, or platinum. The substrate of the anode can be any conventional substrate. Preferably, the substrate for supporting the anode, the function medium is plastic or non-alkali glass. The most preferred material for anode of the light-emitting device or the electroluminescence device is ITO from the standpoint of producibility, electrical conductivity and transparency. The preparation of the anode can be accomplished by any conventional method. The preferred method for forming an anode on the substrate is sputtering method, a resistively-heated vacuum evaporation method, electron beam method, or sol-gel method. There is no limit for the thickness of the anode. The thickness of the anode preferably ranges from 100 nm to 300 nm. The anode can be selectively cleaned with detergent to remove organic residues and treated with UV and/or ozone to lower the driving voltage of the device or enhance the light-emitting efficiency of the device.

The cathode of the light-emitting device or the electroluminescence device of the present invention can be made of any conventional conductive materials having a relatively low work function. Preferably, the cathode of the light-emitting device or the electroluminescence device of the present invention is made of aluminum, calcium, magnesium or magnesium-silver alloy. The most preferred materials of the light-emitting device or the electroluminescence device of the present invention are magnesium-silver alloy. The preparation of the cathode can be accomplished by any conventional method. Preferably, the method for forming cathode of the light-emitting device or the electroluminescence device of the present invention is sputtering method, resistively-vaporized vacuum evaporation method, electron beam method. In case of forming a single metal as a cathode, vacuum-vaporized is preferred. Alternatively, two or more components may be vacuum-vaporized at the same time. The thickness of the cathode preferably ranges from 100 nm to 500 nm.

The process for the formation of the functional medium layer of the light-emitting device or the electroluminescence device of the present invention is not specifically limited. The preferred method for forming the functional medium layer of the light-emitting device or the electroluminescence device of the present invention is (spin) coating method, ink-jet method, LB method or printing method. The most preferred method is coating method.

Hereinafter, the present invention will be explained in detail with said composition used as red light-emitting device material and a red light-emitting device adopting the same.

### EXAMPLE 1

Synthesis of Red Light-Emitting Device Material as Displayed by Formula (II)

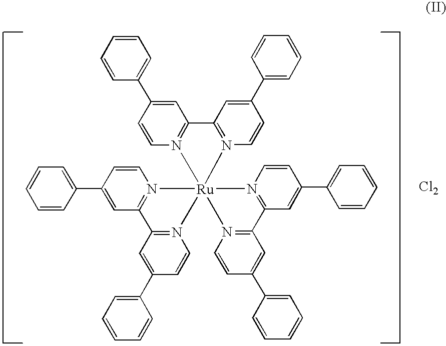

According to the following reaction. To a solution of 0.15 g of ruthenium trichloride monohydrate in 40 ml of dry ethanol were then added 1.0 g of 4,4′-diphenyl-2,2′ dipyridyl. The mixture were heated and refluxed with stirring for 72 hours under nitrogen. After the termination of reaction, the majority of ethanol was rotary evaporated. The residue was then added water to obtain a precipitate. The resulting orange-red solid was withdrawn by filtration, and then dried to obtain 0.41 g of the desired compound of formula (II). The product yield was 62.3%.

¹H—NMR (200 MHz, D₂O): δ7.55 (18H, m); 7.85 (6H, d, J=6.0 Hz); 7.94 (12H, d, J=6.0 Hz); 8.19 (6H, d, J=6.0 Hz); 8.846 (6H, s) MS(70 eV): 1026.4(M⁺); 872.0; 716.3; 563.2; 409.1 λₘₐₓ(abs., MeOH) 475 nm; λₘₐₓ(PL, MeOH)612 nm

### EXAMPLE 2

Synthesis of Red Light-Emitting Device Material as Displayed by Formula (III)

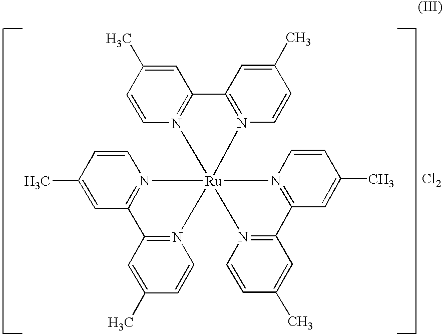

According to the following reaction. To a solution of 0.12 g of ruthenium trichloride monohydrate in 20 ml of dry ethanol were then added 0.49 g of 4,4′-dimethyl-2,2′dipyridyl. The mixture were heated and refluxed with stirring for 72 hours under nitrogen. After the termination of reaction, the majority of ethanol was rotary evaporated. A proper amount of water and benzene were added to extract and separate the unreacted 4,4′-dimethyll-2,2′dipyridyl. The residue was then added water and to obtain a precipitate. The resulting orange-red solid was withdrawn by filtration, and then dried to obtain 0.194 g of the desired compound of formula (III). The product yield was 63.6%.

¹H—NMR (200 MHz, D₂O): δ2.33 (18H, s); 7.00 (6H, d, J=5.4 Hz); 7.42 (6H, d, J=5.4 Hz); 8.16 (6H, s) MS(70 eV): 563.2(M⁺) λₘₐₓ(abs., MeOH) 458 nm; λₘₐₓ(PL, MeOH) 604 nm

### EXAMPLE 3

Synthesis of Red Light-Emitting Device Material as Displayed by Formula (IV)

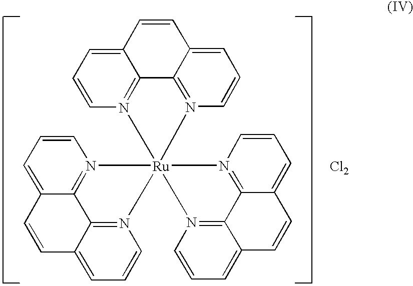

According to the following reaction. To a solution of 0.23 g of ruthenium trichloride monohydrate in 40 ml of dry ethanol were then added 1.0 g of 1,10-Phenanthroline. The mixture were heated and refluxed with stirring for 72 hours under nitrogen. After the termination of reaction, the majority of ethanol was rotary evaporated. A proper amount of water and benzene were added to extract and separate the unreacted 1,10-Pheanthroline. The residue was then added water to obtain a precipitate. The resulting orange-red solid was withdrawn by filtration, and then dried to obtain 0.42 g of the desired compound of formula (IV). The product yield was 64.7%.

¹H—NMR (200 MHz, D₂O): δ7.43 (6H, dd, J=5.2 Hz, J=8.2 Hz); 7.94 (6H, d, J=5.2 Hz); 8.07 (6H, s); 8.42 (6H, d, J=8.2 Hz) MS(70 eV): 642.8(M⁺) λₘₐₓ(abs., MeOH) 445 nm; λₘₐₓ(PL, MeOH) 577 nm

### EXAMPLE 4

Light-Emitting Device Containing Red Light-Emitting Material as Formula (II)

Poly(N-vinylcarbazole) in an amount of 100 mg, PBD [2-(4-t-butylphenyl)-1,3,4-oxadiazole] in an amount of 40 mg, and 0.5 mg of the light-emitting material of formula (II) were dissolved in 10 ml of chloroform, and spin-coated on a cleaned substrate (1000 rpm, 40 sec). The thickness of the thus formed organic layer was about 10 nm. A patterned mask was put on the thin organic layer, and installed in a vacuum evaporator apparatus. Mg and Ag were deposited successively on the thin organic layer via the patterned mask, thereby forming a metallic film having a thickness of 30 nm and 150 nm respectively. The EL device thus obtained was made to luminescence by applying a DC voltage by means of a source measure unit, and examined for luminance and wavelengths of luminescence by using a luminometer OMSI 2000i made by Karger Electronik. As a result, it was found that the luminescence was red and a better red chromaticity value (x, y) of 0.64 and 0.33 had been emitted, the wavelength at which the luminescence had the maximum luminance (EL max.) was 625 nm. The luminescence initiating voltage was 15 V.

### EXAMPLE 5

Light-Emitting Device Containing Red Light-Emitting Material as Formula (II)

Poly(N-vinylcarbazole) in an amount of 100 g, PBD [2-(4-t-butylphenyl)-1,3,4-oxadiazole] in an amount of 40 mg, and 1.0 mg of the light-emitting material of formula (II) were dissolved in 10 ml of chloroform, and spin-coated on a cleaned substrate (1000 rpm, 40 sec). The thickness of the thus formed organic layer was about 10 nm. A patterned mask was put on the thin organic layer, and installed in a vacuum evaporator apparatus. Mg and Ag were deposited successively on the thin organic layer via the patterned mask, thereby forming a metallic film having a thickness of 30 nm and 150 nm respectively. The EL device thus obtained was made to luminescence by applying a DC voltage by means of a source measure unit, and examined for luminance and wavelengths of luminescence by using a luminometer OMSI 2000i made by Karger Electronik. As a result, it was found that the luminescence was red and a better red chromaticity value (x, y) of 0.64 and 0.33 had been emitted, the wavelength at which the luminescence had the maximum luminance (EL max.) was 625 nm. The luminescence initiating voltage was 19 V.

### EXAMPLE 6

Light-Emitting Device Containing Red Light-Emitting Material as Formula (II)

Poly(N-vinylcarbazole) in an amount of 100 g, PBD [2-(4-t-butylphenyl)-1,3,4-oxadiazole] in an amount of 40 mg and 4.0 mg of the light-emitting material of formula (II) were dissolved in 10 ml of chloroform, and spin-coated on a cleaned substrate (1000 rpm, 40 sec). The thickness of the thus formed organic layer was about 10 nm. A patterned mask was put on the thin organic layer, and installed in a vacuum evaporator apparatus. Mg and Ag were deposited successively on the thin organic layer via the patterned mask, thereby forming a metallic film having a thickness of 30 nm and 150 nm respectively. The EL device thus obtained was made to luminescence by applying a DC voltage by means of a source measure unit, and examined for luminance and wavelengths of luminescence by using a luminometer OMSI 2000i made by Karger Electronik. As a result, it was found that the luminescence was red and a better red chromaticity value (x, y) of 0.65 and 0.33 had been emitted, the wavelength at which the luminescence had the maximum luminance (EL max.) was 630 nm. The luminescence initiating voltage was 15 V.

### EXAMPLE 7

Light-Emitting Device Containing Red Light-Emitting Material as Formula (II)

Poly(N-vinylcarbazole) in an amount of 100 g, 40 mg of PBD [2-(4-t-butylphenyl)-1,3,4-oxadiazole] and 10.0 mg of the light-emitting material of formula (II) were dissolved in 10 ml of chloroform, and spin-coated on a cleaned substrate (1000 rpm, 40 sec). The thickness of the thus formed organic layer was about 10 nm. A patterned mask was put on the thin organic layer, and installed in a vacuum evaporator apparatus. Mg and Ag were deposited successively on the thin organic layer via the patterned mask, thereby forming a metallic film having a thickness of 30 nm and 150 nm respectively. The thus produced EL device was made to luminescence by applying a DC voltage by means of a source measure unit, and examined for luminance and wavelengths of luminescence by using a luminometer OMSI 2000i made by Karger Electronik. As a result, it was found that the luminescence was red and a better red chromaticity value (x, y) of 0.65 and 0.33 had been emitted, the wavelength at which the luminescence had the maximum luminance (EL max.) was 635 nm. The luminescence initiating voltage was 22 V.

### EXAMPLE 8

Light-Emitting Device Containing Red Light-Emitting Material as Formula (III)

Poly(N-vinylcarbazole) in an amount of 100 g, PBD [2-(4-t-butylphenyl)-1,3,4-oxadiazole] in an amount of 40 mg and 4.0 mg of the light-emitting material of formula (III) were dissolved in 10 ml of chloroform, and spin-coated on a cleaned substrate (500 rpm, 40 sec). The thickness of the thus formed organic layer was about 10 nm. A patterned mask was put on the thin organic layer, and installed in a vacuum evaporator apparatus. Mg and Ag were deposited successively on the thin organic layer via the patterned mask, thereby forming a metallic film having a thickness of 30 nm and 150 nm respectively. The thus produced EL device was made to luminescence by applying a DC voltage by means of a source measure unit, and examined for luminance and wavelengths of luminescence by using a luminometer OMSI 2000i made by Karger Electronik. As a result, it was found that the luminescence was red and a better red chromaticity value (x, y) of 0.65 and 0.34 had been emitted, the wavelength at which the luminescence had the maximum luminance (EL max.) was 615 nm. The luminescence initiating voltage was 27 V.

### EXAMPLE 9

Light-Emitting Device Containing Red Light-Emitting Material as Formula (IV)

Poly(N-vinylcarbazole) in an amount of 100 g, 40 mg of PBD [2-(4-t-butylphenyl)-1,3,4-oxadiazole] and 10.0 mg of the light-emitting material of formula (1) were dissolved in 10 ml of chloroform, and spin-coated on a cleaned substrate (1000 rpm, 40 sec). The thickness of the thus formed organic layer was about 10 nm. A patterned mask was put on the thin organic layer, and installed in a vacuum evaporator apparatus. Mg and Ag were deposited successively on the thin organic layer via the patterned mask, thereby forming a metallic film having a thickness of 30 nm and 150 nm respectively. The thus produced EL device was made to luminescence by applying a DC voltage by means of a source measure unit, and examined for luminance and wavelengths of luminescence by using a luminometer OMSI 2000i made by Karger Electronik. As a result, it was found that the luminescence was red and a better red chromaticity value (x, y) of 0.64 and 0.33 had been emitted, the wavelength at which the luminescence had the maximum luminance (EL max.) was 645 nm. The luminescence initiating voltage was 3 V.

From the descriptions above, we can realize that the present invention provides a new compound and a new composition used as red light materials for electroluminescence devices, which emits red light with wavelength ranging from 600 nm to 650 nm. That means this composition can provide good color purity and suitable to serve as pure red light-emitting material. Thus, the present invention also provides a light-emitting device or an electroluminescence device having excellent red chromaticity and a light-emitting material which can form such a light emitting device to have such characteristics, and a light-emitting material which can be used in various fields.

Although the present invention has been explained in relation to its preferred embodiment, it is to be understood that many other possible modifications and variations can be made without departing from the spirit and scope of the invention as hereinafter claimed.

What is claimed is:

1. A compound of formula (I): 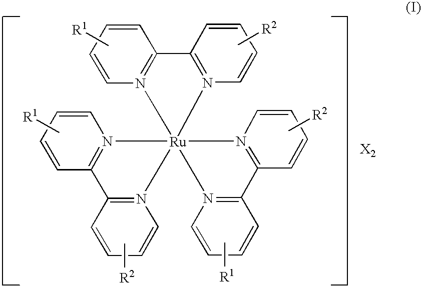
wherein each R¹ and R² independently is C₁₋₃ alkyl, C₆₋₁₀ aryl, or R¹ and R² are together to be —(CH═CH)—; X is Cl or Br.

2. The compound as claimed in claim 1, wherein each said R¹ and R² independently is methyl.

3. The compound as claimed in claim 1, wherein each said R¹ and R² independently is phenyl.

4. The compound as claimed in claim 1, wherein said R¹ and R² are together to be cis-(CH═CH)—.

5. The compound as claimed in claim 1, wherein said X is Cl.

6. A composition used for light-emitting medium of an electro-luminescence device, comprising:
a polymer matrix; and
a compound of formula (I): 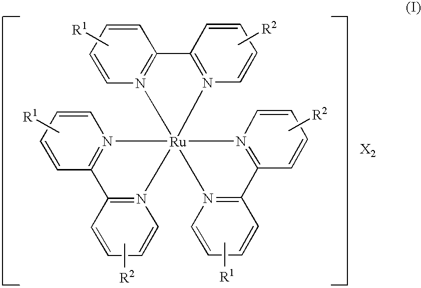
wherein each R¹ and R² independently is C₁₋₃ alkyl, C₆₋₁₀ aryl, or R¹ and R² are together to be —(CH═CH)—; X is Cl or Br.

7. The composition claimed as claim 6, wherein each said R¹ and R² independently is methyl.

8. The composition as claimed in claim 6, wherein each said R¹ and R² independently is phenyl.

9. The composition as claimed in claim 6, wherein said R¹ and R² are together to be cis-(CH═CH)—.

10. The composition as claimed in claim 6, wherein said X is Cl.

11. The composition as claimed in claim 6, wherein said polymer matrix is ??, or ??.

12. An electroluminescence device, comprising:
at least one cathode,
at least one anode, and
a functional medium polymer doped with at least one compound as formula (I): 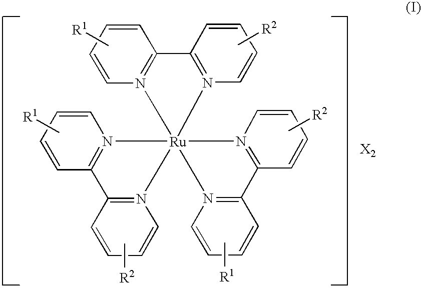
wherein each R¹ and R² independently is C₁₋₃ alkyl, C₆₋₁₀ aryl, or R¹ and R² are together to be —(CH═CH)—; X is Cl or Br; and said functional medium is sandwiched between said cathode and said anode.

13. The electroluminescence device as claimed in claim 12, wherein each said R¹ and R² independently is methyl.

14. The electroluminescence device as claimed in claim 12, wherein each said R¹ and R² independently is phenyl.

15. The electroluminescence device as claimed in claim 12, wherein said R¹ and R² are together to be cis-(CH═CH)—.

16. The electroluminescence device as claimed in claim 12, wherein said X is Cl.

17. The electroluminescence device as claimed in claim 12, wherein said functional medium layer is prepared by blade coating, spin coating, LB film coating, ink-jet spraying, or printing.

18. The electroluminescence device as claimed in claim 12, wherein said anode is at least one selected from the group consisting of indium tin oxide (ITO), gold, and platinum on non-alkali glass.

19. A red light-emitting device claimed as claim 5, wherein said cathode is made of at least one material selected from the group consisting of aluminum, calcium, magnesium and magnesium-silver alloy.
